(19) United States
(12) Patent Application Publication
(10) Pub. No.: US 2015/0292242 A1
(43) Pub. Date: Oct. 15, 2015

(54) ENCLOSURES WITH INTEGRATED LOCKING SYSTEM

(71) Applicant: S&C Electric Company, Chicago, IL (US)

(72) Inventor: Joseph P. MONINSKI, Arlington Heights, IL (US)

(21) Appl. No.: 14/680,419

(22) Filed: Apr. 7, 2015

Related U.S. Application Data
(60) Provisional application No. 61/977,983, filed on Apr. 10, 2014.

(51) Int. Cl. E05B 65/44; E05B 65/52; E05F 15/611; A47B 96/00

(52) U.S. Cl. CPC E05B 65/44; A47B 96/00; E05B 65/52; E05F 15/611

(57) ABSTRACT

An enclosure includes a body portion having a first slotted opening, a top portion including a rotatable lid component to provide access to an interior compartment of the enclosure. A locking assembly integral with the lid component includes an actuator component rotatably coupled to a side surface of the lid component and having a first threaded end portion and an actuator axis. The locking assembly further includes a drive cylinder having a second threaded end portion configured to receive the first threaded portion of the actuator component, wherein the drive cylinder is slideably coupled to the lid component. Rotation of the actuator component from a first position to a second position causes the drive cylinder to translate parallel to the actuator axis. The locking assembly further includes a first latch structure rigidly coupled to the drive cylinder to engage and disengage the first slotted opening.

### CROSS-REFERENCE TO RELATED APPLICATIONS

[0001.] This application claims the benefit of U.S. Provisional Application No. 61/977,983 filed on Apr. 10, 2014, the entire disclosure of which is incorporated herein by reference.

### TECHNICAL FIELD

The technical field generally relates to enclosures, such as pad-mounted enclosures, and more particularly relates to locking systems for such enclosures.

### BACKGROUND

Power distribution systems often utilize underground distribution (“UD”) switchgear enclosures that include one or more compartments designed to house and protect the various electrical components used in conjunction with such systems, including load-interrupter switches, fault interrupters, cabling, and the like. One type of such switchgear enclosure is the “pad-mounted” enclosure, which typically includes a lockable metal enclosure mounted on a concrete pad in an outdoor location. Enclosures of this type may be configured to provide access to internal components via one or more removable panels, doors, and lids.

Known enclosures of the type described above may be unsatisfactory in a number of respects. For example, many enclosures—particularly those incorporating a lid or roof component—often include a complex arrangement of recesses and cavities associated with the various handles, padlock attachment holes, locking bolt access openings, and other such features of the enclosure. These features provide numerous potential nesting areas for wasps and other insects that can impede an operator's access to the enclosure. Furthermore, the geometric complexity of such roof components, panels, recesses, etc. might present an unsightly view as installed in residential areas.

Accordingly, there is a need for improved enclosure systems that are relatively simple in form, are aesthetically pleasing, are not subject to nesting insects, and are easy to lock and unlock by an operator. Other desirable features and characteristics of the present invention will become apparent from the subsequent detailed description and the appended claims, taken in conjunction with the accompanying drawings and the foregoing technical field and background.

### DESCRIPTION OF THE DRAWINGS

The exemplary embodiments will hereinafter be described in conjunction with the following drawing figures, wherein like numerals denote like elements, and wherein:

FIG. 1 is an isometric overview of an enclosure in accordance with one embodiment;

FIG. 2 is an isometric close-up view of region “2” of FIG. 1, depicting a recessed actuator in accordance with one embodiment;

FIG. 3 is an end-on view of the recessed actuator of FIG. 2;

FIG. 4 is an isometric overview of the enclosure of FIG. 1 in a partially open state;

FIG. 5 is a partial exploded view of a locking assembly in accordance with one embodiment;

FIG. 6 is close-up of various components of a locking assembly in accordance with one embodiment;

FIG. 7 is a cross-sectional view at section “7” of FIG. 2;

FIG. 8 depict an exemplary hasp access system in the closed position;

FIG. 9 depict the hasp access system of FIG. 8 in the opened position;

FIG. 10 is an isometric view of an exemplary hasp access system in accordance with one embodiment;

FIG. 11 is an alternate isometric view of the exemplary hasp access system of FIG. 10;

FIG. 12 is a sectional view of a another exemplary hasp access system shown in the open position; and

FIG. 13 depicts the hasp access system of FIG. 12 in the closed position.

### DETAILED DESCRIPTION

The subject matter described herein generally relates to a clean, geometrically simple enclosure design that avoids the use of cavities and recesses (and thereby prevents nesting insects), and which is easy to lock and unlock by an operator. In this regard, there is no intention to be bound by any expressed or implied principle presented in the preceding technical field, background or the following detailed description. It will be understood that the drawing figures are not necessarily drawn to scale and may be referred to herein, without loss of generality, as “isometric” (as opposed to “perspective”) drawings even when such drawings are not strictly isometric, but are otherwise axonometric as is known in the art.

An enclosure in accordance with one embodiment includes a body portion having a first slotted opening, a top portion including a lid component configured to rotate with respect to the body portion to provide access to an interior compartment of the enclosure, and a locking assembly integral with the lid component. The locking assembly includes: an actuator component recessed within and rotatably coupled to a side surface of the lid component, the actuator component having a first threaded end portion and an actuator axis; a drive cylinder having a second threaded end portion configured to receive the first threaded portion of the actuator component, wherein the drive cylinder is slideably coupled to the lid component such that rotation of the actuator component from a first position to a second position causes the drive cylinder to translate parallel to the actuator axis; and a first latch structure rigidly coupled to the drive cylinder, the first latch structure configured to engage the first slotted opening in the first position, and disengage the first slotted opening in the second position.

A locking assembly for an enclosure in accordance with one embodiment includes an actuator component, a drive cylinder, and a latch structure. The actuator component is recessed within and rotatably coupled to a side surface of a lid component of the enclosure, and has a first threaded end portion and an actuator axis. The drive cylinder has a second threaded end portion configured to receive the first threaded portion of the actuator component, the drive cylinder slideably coupled to the lid component of the enclosure such that rotation of the actuator component from a first position to a second position causes the drive cylinder to translate parallel to the actuator axis. The latch structure is rigidly coupled to the drive cylinder and is configured to engage a slotted opening of the enclosure in the first position, and disengage the slotted opening in the second position.

An enclosure in accordance with one embodiment includes a body portion having a front portion, two opposing side portions, and a back portions. The front portion has a front edge surface including at least one slotted opening. A lid component is configured to rotate with respect to the body portion to provide access to an interior compartment of the enclosure and is oriented at approximately a 45-degree angle with respect to a plane of the front portion of the body portion when the lid component is in a “closed” position. A locking assembly is integral with the lid component, and includes: an actuator component recessed within and rotatably coupled to a side surface of the lid component, the actuator component having a first threaded end portion and an actuator axis; a drive cylinder having a second threaded end portion configured to receive the first threaded portion of the actuator component, wherein the drive cylinder is slideably coupled to the lid component such that rotation of the actuator component from a first position to a second position causes the drive cylinder to translate parallel to the actuator axis; and at least one latch structure rigidly coupled to the drive cylinder, the at least one latch structure configured to engage the at least one slotted opening in the first position, and disengage the at least one slotted opening in the second position.

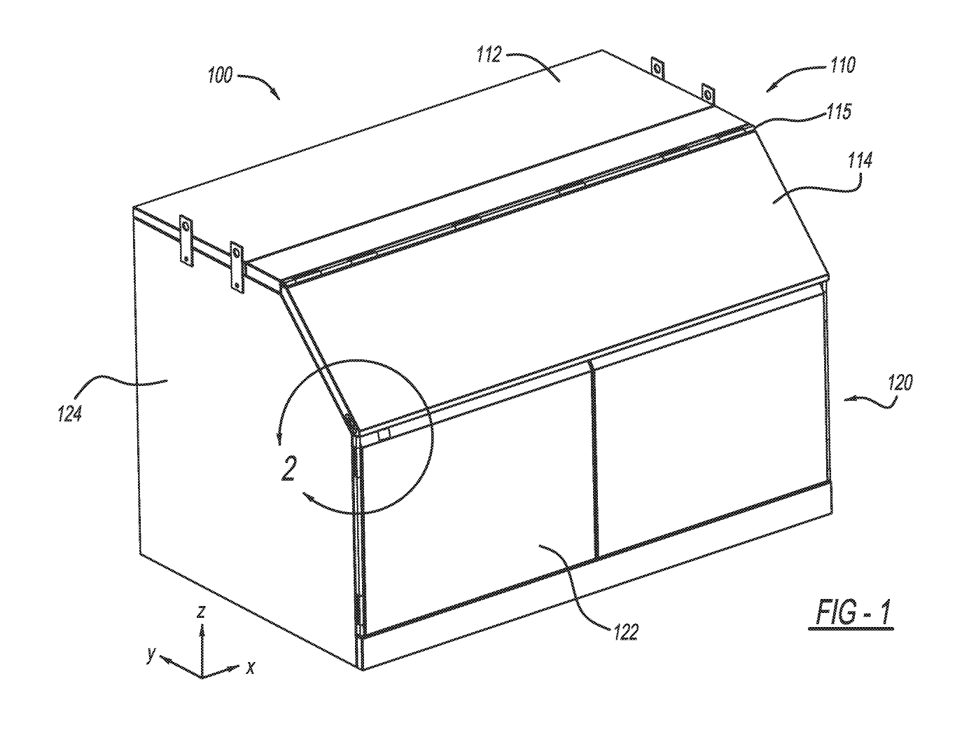

Referring now to FIG. 1, an exemplary enclosure 100 (depicted in the closed position) generally includes a top (or “ma”) portion 110 and a body portion (or simply “body”) 120. Top portion 110 includes a lid component (or simply “lid”) 11.4 configured to rotate with respect to body portion 120 (e.g., via a hinge 115 or other such rotational component or components) to provide access to an interior compartment of enclosure 100 (as will be shown in subsequent figures). Top portion 110 may also include a stationary roof component 112 rigidly coupled to or otherwise incorporated into body portion 120.

In the illustrated embodiment, body portion 120 is generally rectilinear and includes two opposing side portions 124 (only one visible in the figure), as well as a front portion 122 and a back portion (not shown) opposite front portion 122. Similarly, lid component 114 is depicted as a rectangular panel hingedly connected (via hinge component 115) along one full edge to stationary roof component 112. It will be appreciated, however, that the embodiments are not so limited and may include any suitable combination of rectilinear and/or curvilinear shapes.

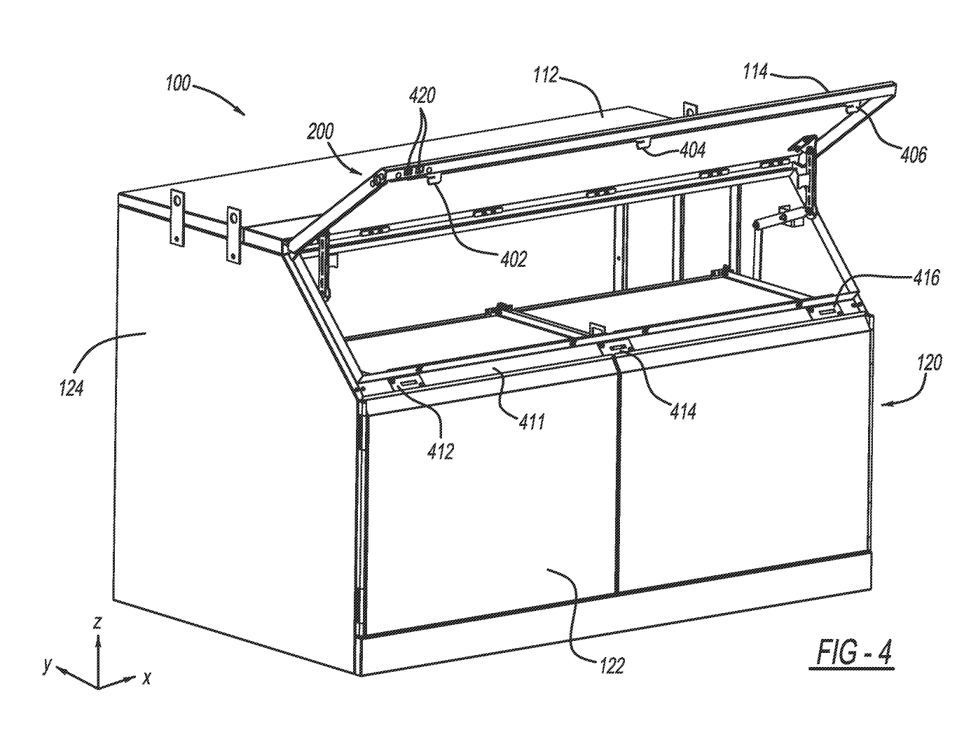

Front portion 122 may include one or more panels or doors (such as the two horizontally adjacent panels shown in FIG. 1) providing access to the interior of the enclosure. In one embodiment, the panels of front portion 122 are configured such that front portion 122 is secured at its top edge by the front edge of lid 114 when lid 114 is in a “closed” position, as shown in FIG. 4. In one embodiment, lid component 114 is oriented at approximately a 45-degree angle with respect to a plane defined by front portion 122 of body portion 120 when lid component 114 is in a “closed” position, thereby avoiding the accumulation of rain and/or snow on the top portion 110.

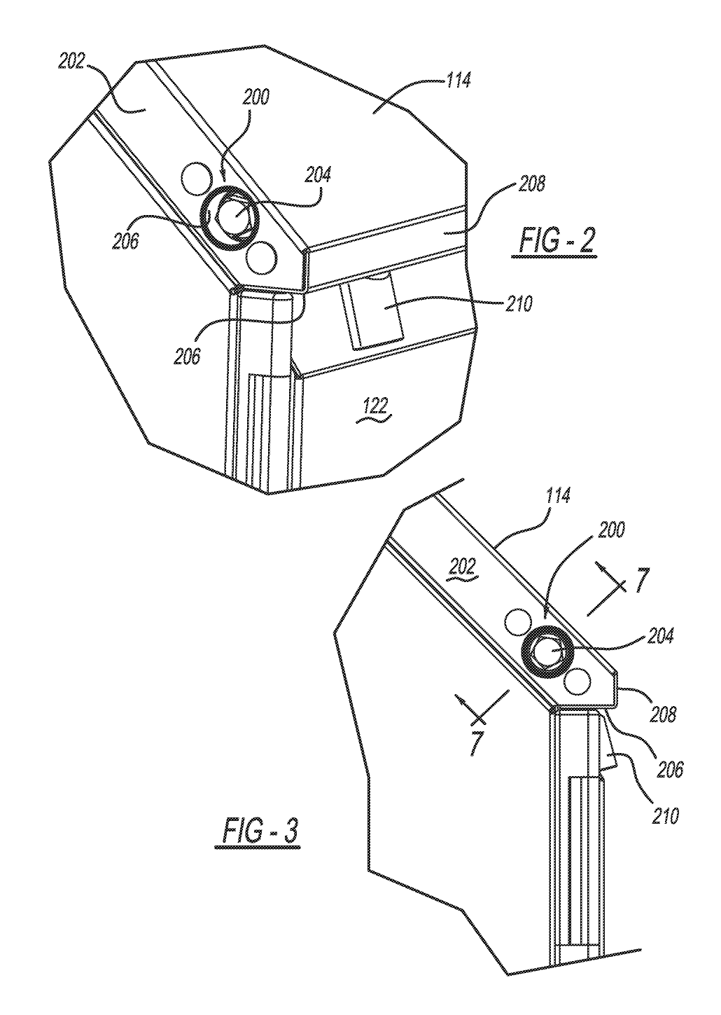

FIG. 2 is an isometric close-up view of region “2” of FIG. 1 and illustrates a recessed actuator component (or simply “actuator”) 200 that forms part of a locking assembly in accordance with one embodiment. More particularly, a side edge surface 202 of lid 114 includes a generally circular recessed region 206 that has a depth selected to substantially house actuator 200. In the illustrated embodiment, actuator 200 includes a bolt head 204 (such as a pentahead bolt head as illustrated), and the depth of recess 206 is greater than the axial dimension of bolt head 204. As described in further detail below, actuator 200 is configured to be manually rotated by an operator to lock and unlock lid 114 from the body of the enclosure. In this regard, FIG. 2 depicts lid 114 in the closed state, and also illustrates a removable locking apparatus 210 (e.g., a conventional padlock) which may be secured in corresponding hasp openings (not illustrated) when lid 114 is in the closed state. As will be appreciated, recess 206 provides substantial concealment of actuator 200 by lid 114 while also not providing a cavity large enough to attract nesting insects.

FIG. 3 provides an end-on view of the recessed actuator of FIG. 2, and further illustrates the geometry of lid 114, which includes a lid front edge surface 208 and a lid bottom edge surface 206. In the illustrated embodiment, surfaces 206 and 208 are substantially perpendicular to each other and interface with front portion 122 (as shown in FIG. 2) such that there are also no insect-attracting cavities between lid 114 and front portion 122 in the closed position.

FIG. 4 is an isometric overview of the enclosure of FIG. 1 in a partially open state (i.e., after actuator 200 has been rotated to an unlocked position and lid 114 has been raised). As shown, body portion 120 of enclosure 100 includes three openings (referred to without loss of generality as “slotted openings”) 412, 414, and 416, which are configured to engage (and disengage) corresponding latch components 402, 404, and 406 that are incorporating into a locking assembly as further detailed below. While three latch components are illustrated in FIG. 4, the invention is not so limited. Any number of such latch components 402, 404, 406 and slotted openings 412, 414, 416 may be employed in any particular application.

Also depicted in FIG. 4, lid component 114 further includes one or more hasp openings 420 configured to receive a shackle member (e.g., from a typical padlock, as depicted in FIG. 3). While this feature will be described in further detail below, the locking assembly includes a hasp access component configured to selectably “block” hasp openings 420 depending upon whether latch components 402, 404, 406 and slotted openings 412, 414, 416 are engaged or disengaged.

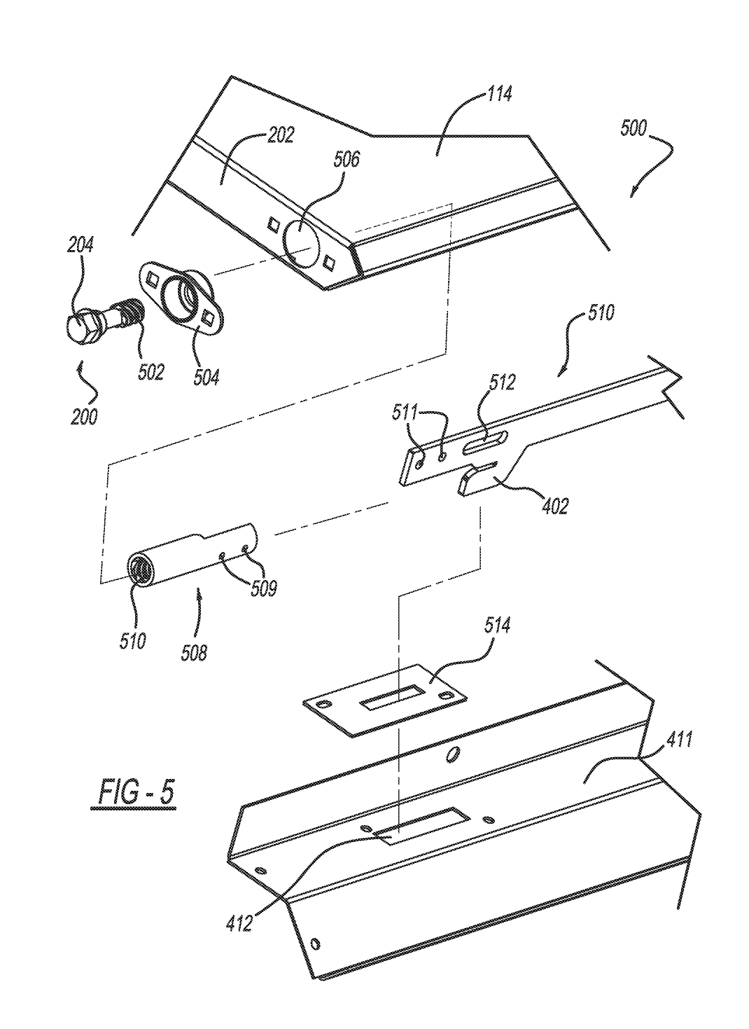

FIG. 5 is a partial exploded view of a locking assembly 500 in accordance with one embodiment. More particularly, locking assembly 500 includes actuator component 200, drive cylinder 508, latch bar 510, and latch structure(s) 402. Actuator component 200, as previously mentioned, is recessed (via recessed flange 504) within side surface 202 of the lid component 114. Actuator component is configured to rotate within flange 504 and has a threaded end portion 502 (e.g., a threaded outer diameter) and a bolt head (e.g., pentahead bolt head) 204 that can be gripped and rotated with a corresponding bolt head tool, as is known in the art.

Drive cylinder 508 (which may or not be strictly cylindrical) includes a threaded end portion 510 (e.g., a threaded inner diameter) configured to receive threaded portion 502 of actuator component 200. Drive cylinder 508 is rigidly secured to latch bar 510 via, for example, mounting holes 509 and 511 and suitable attachment hardware (not illustrated). Drive cylinder is slideably coupled to lid 114 through a suitable sliding support (not illustrated in FIG. 5) such that rotation of actuator component 200 causes drive cylinder 508 (and consequently latch bar 510) to translate parallel to the axis of actuator 200. Stated another way, rotation of actuator 200 clockwise and counterclockwise causes corresponding side-to-side movement of latch bar 510.

Latch bar 510 includes a latch structure 402 (also shown in FIG. 4) that is configured to engage the slotted opening 412 when actuator is in a first position, and disengage the slotted opening 412 in a second position. A support plate 514 may be secured to body front edge surface 411 to add structural support in the vicinity of slotted opening 412, as shown.

Threaded portion 502 of actuator 200 (and corresponding threaded portion 510 of drive cylinder 508) may be implemented using a variety of thread configurations. In one embodiment, threaded portion 502 is configured such that rotation of actuator component 200 from a “locked” position to an “unlocked” position (which may be effected via counterclockwise rotation, for example) requires approximately one full turn. In one embodiment, threaded portion 502 is configured with a pitch of one turn-per-inch. That is, rotation of actuator 200 causes drive cylinder 508 to translate one inch (e.g., to the right in FIG. 5) in response to the rotation of actuator 200 by one turn. In one embodiment, threaded portion 502 includes more than one and preferably four helical “lead-ins” (e.g., a four-lead or multi-lead thread) as is known in the art and as depicted in FIG. 5.

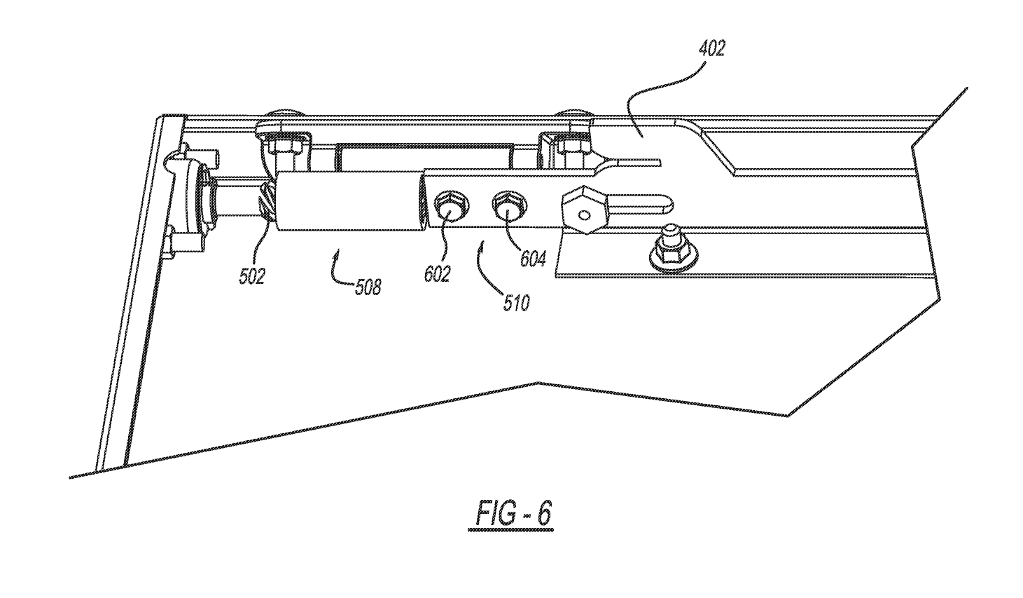

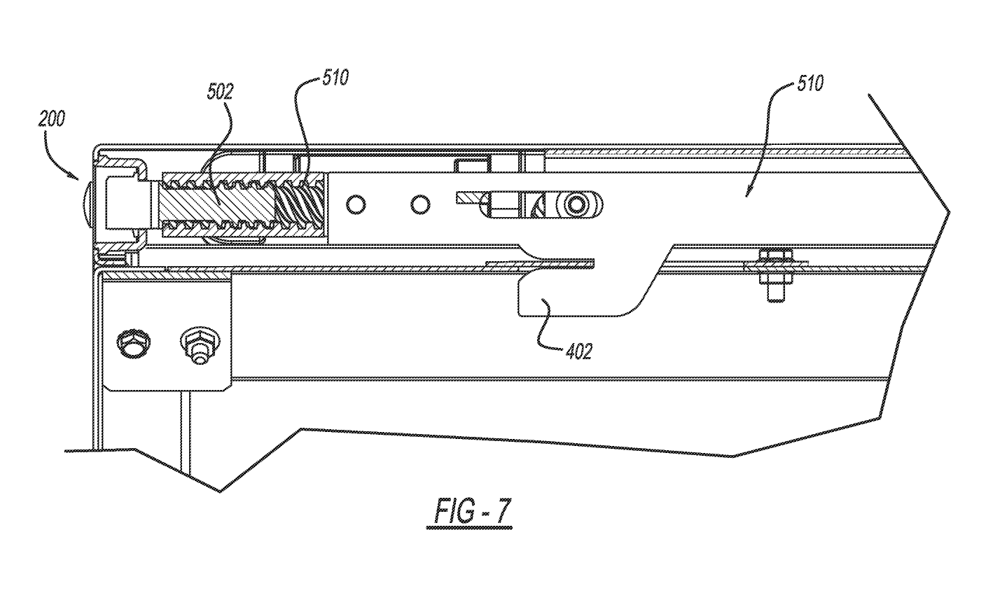

FIG. 6 is close-up depicting the various components of FIG. 5 in an assembled state (and as would be seen from a viewpoint beneath the front edge of lid 114). As shown, drive cylinder 508 is rigidly secured to latch bar 510 via suitable bolt components 602 and 604 (through holes 511 and 509 in FIG. 5). In this illustration, threaded portion 502 is only partially engaged by drive cylinder 508. FIG. 7 is a cross-sectional view at section “7” of FIG. 2, and roughly corresponds to the features depicted in FIG. 6. This figure illustrates the case where threaded portion 502 of actuator 200 is fully received within drive cylinder 510.

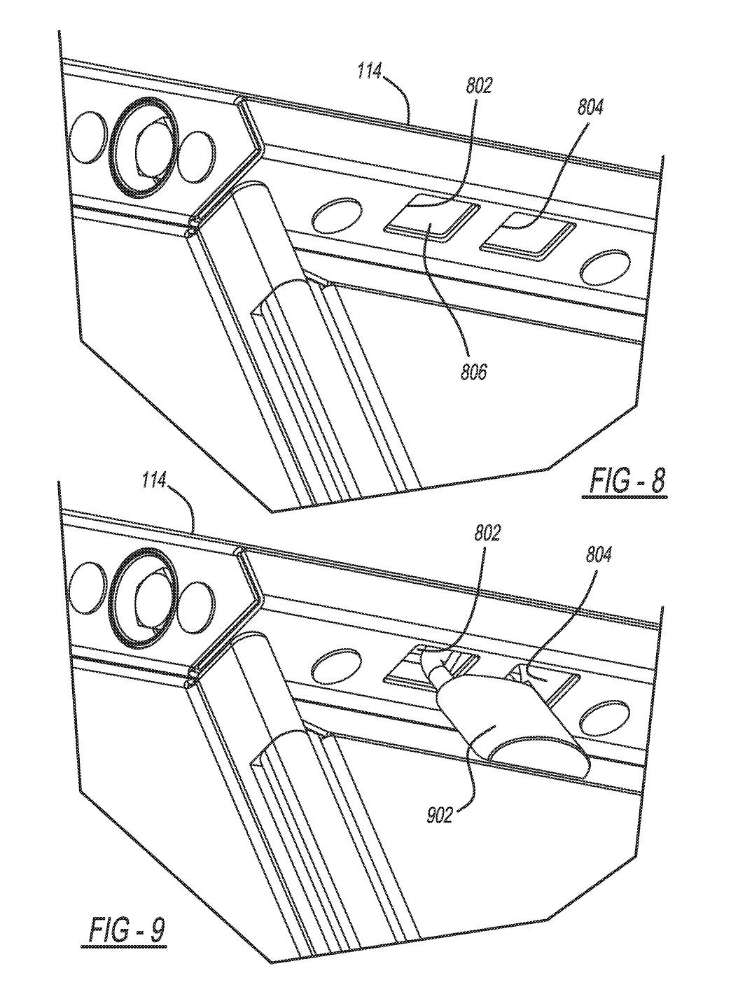

FIGS. 8 and 9 depict an exemplary hasp access system in the closed and opened positions, respectively, as viewed from the exterior of the enclosure (i.e., viewing the front edge of lid component 114 from below). As shown, lid component 114 includes two adjacent hasp openings 802 and 804, which are configured to receive an external shackle member, such as the “U”-shaped shackle of a conventional padlock. FIG. 8 depicts the hasp openings 802, 804 in a “closed” state (corresponding to the enclosure being unlocked and opened) in that a hasp access bracket 806 is placed such that it “blocks” the insertion of a shackle through openings 802 and 804. The hasp access bracket 806 is coupled to the latch bar 510 so that it moves in a side-to-side motion therewith. The hasp access bracket has a pair of holes that align with the hasp opening 802, 804 when the actuator component 200 is in the locked position. When the actuator component 200 is in the opened position, the hasp access bracket 806 moves laterally such that the pair of hole are no longer aligned with the hasp openings 802, 804 but rather blocked by the hasp access bracket. In contrast, FIG. 9 depicts the hasp openings 802, 804 in an “open” state and with a padlock 902 inserted and locked. The shackle of padlock 902 extends through the hasp access bracket 806 which is rigidly coupled to the latch bar 510, thereby locking out rotation of the drive cylinder 508.

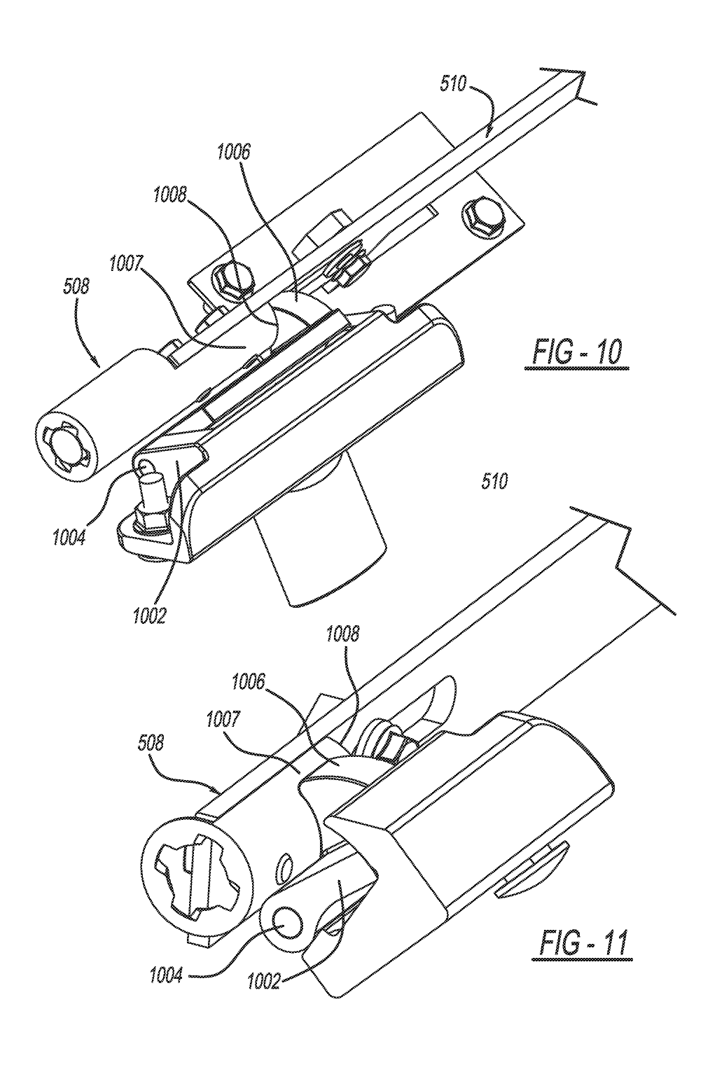

FIG. 10 is an isometric view of an exemplary hasp access system in accordance with an alternate embodiment, and FIG. 11 is an alternate isometric view of the exemplary hasp access system of FIG. 10. FIGS. 10 and 11 provide a view from “behind” the hasp openings shown in FIGS. 8 and 9, and are thus not visible in these figures. FIG. 10 depicts the case where the hasp openings are “open” (as shown in FIG. 9, with a padlock inserted), and FIG. 10 depicts the case where the hasp openings are “closed” (as shown in FIG. 8, with no padlock inserted). In general, the illustrated embodiment includes a pre-loaded blocking component 1002 that pivots about a pin 104 and which has an arcuate tab 1006 that selectably interferes with (and prevents lateral translation of) shoulder 1008 of drive cylinder 508. The unseen surface or face of blocking component 1002 in FIGS. 10 and 11 corresponds to surface 806 of FIG. 8.

Blocking component 1002 is “pre-loaded” with torsional stress (via, for example, a captured spring or other torsional component) such that it has a tendency to rotate about pin 1004 (in approximately the clockwise direction in FIG. 10). In FIG. 10, the presence of the padlock shackle prevents clockwise rotation of blocking component 1002 about pin 1004, as a result, arcuate tab 1006 is trapped close to latch bar 510 and thus captures shoulder 1008 of drive cylinder 508. Thus, FIG. 10 corresponds to the condition where the enclosure is closed, locked, and drive cylinder 508 cannot be moved via actuator 200 (FIG. 5). As shown in FIG. 9, hasp openings 802 and 804 are effectively “filled” by the shackle of padlock 902, and are therefore not attractive to insects as a possible nesting place.

In contrast, FIG. 11 corresponds to the condition where no padlock shackle is present, and the enclosure is open and unlocked. As shown, pre-loaded blocking component 1002 is now free to rotate clockwise about pin 1004 such that its face presses up against the inner surface of the lid to block the hasp openings (as depicted in FIG. 8). Similarly, drive cylinder 508 is free to translate laterally, and in this figure is seen to be slightly to the right of its position in FIG. 10. In this state, arcuate tab 1006 will not interfere with shoulder 1008, and may now ride adjacent to surface 1007 of drive cylinder 508 without impeding its movement.

FIGS. 10 and 11 depict the axis of pivot 1004 as being parallel to the axis of drive cylinder 508. However, the invention is not so limited. Pivot 1004 may be oriented in a variety of directions that allow blocking component 1002, to move into a position that effectively blocks the hasp openings. In an alternate embodiment, for example, the axis of pin 1004 is oriented perpendicular to the axis of drive cylinder 508 and is rotatably secured to one end of component 1002.

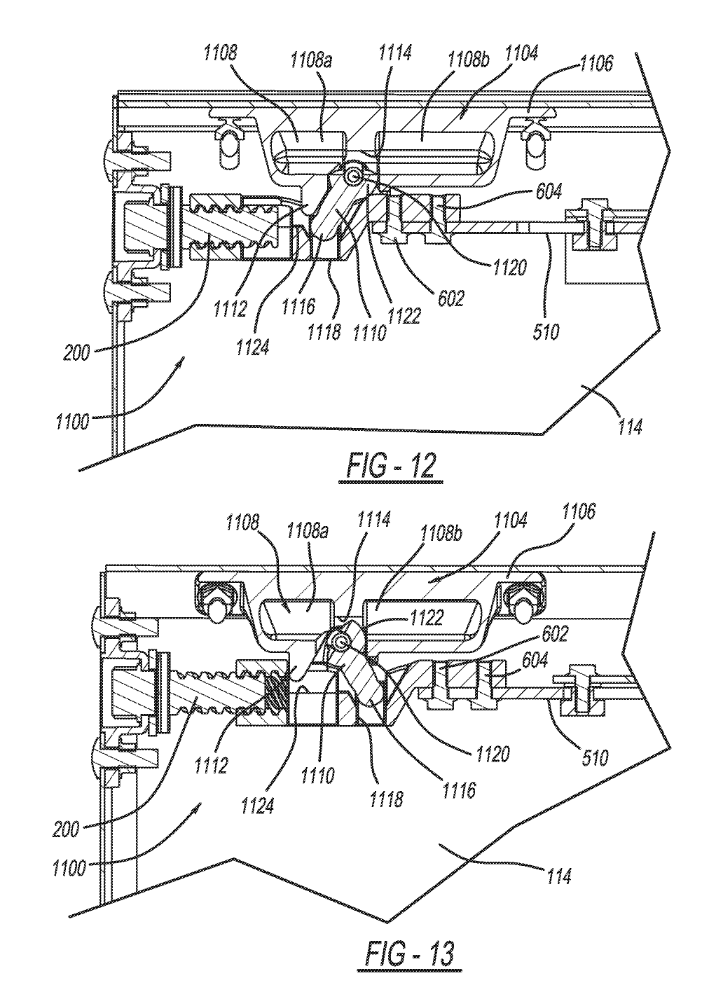

FIGS. 12 and 13 depicts another alternate embodiment of a mechanism for selective access to the hasp locking function. Hasp access system 1100 includes a drive cylinder 1102 which is similar in structure and function to drive cylinder 508 in that it is operably coupled to the actuator component 200 a secured to the latch bar 510 via bolts 602, 604. Rotation of the actuator component 200 causes drive cylinder 1102 to translate parallel to the axis of actuator component 200. Hasp access system 1100 also include a hasp housing assembly 1104 which is secured to the lid component 114. The hasp housing assembly 1104 includes a housing 1106 defining a hasp cavity 1108, a toggle 1110 pivotally supported to the housing 1106 and a stop 1112. As presently preferred, the components of the hasp access system 1100 may be simple die-cast components.

The housing 1106 divides hasp cavity 1108 into first and second regions 1108a, 1108b which align with the hasp openings formed through the lid component (see 804, 806 in FIG. 8). In this way, the housing 1106 covers these openings and minimize areas where insects may nest. A shackle passageway 1114 is formed between the first and second regions 1108a, 1108b. The toggle 1110 has a lever portion 1116 extending from the housing 1106 and into a slot 1118 formed in the drive cylinder 1102. Movement of the drive cylinder 1102 results in rotation of the toggle 1110 about the pivot axis 1120. As the drive cylinder 1102 translates, rotation of the toggle 1110 moves the head portion 1122 into the shackle passageway 1114, thus blocking access between the first and second cavity portions.

When the hasp access system 1100 is in the open position as shown in FIG. 12, a padlock shackle may be inserted into the first cavity portion 1108a through the shackle passageway 1114 and out of the second cavity portions 1108b. When the hasp access system 1110 is in the closed position as shown in FIG. 13, the head portion 1122 of the toggle 1110 rotates into the shackle passageway 1114 and block access between the first and second cavity portions 1108a, 1108b. The stop 1112 form on housing 1106 extend into a slot 1124 formed in the drive cylinder 1102. In the open position, the stop 1112 engages the toggle 1110 to limit the travel of the drive cylinder 1102 to the left (as seen in FIG. 12). In the closed position, the stop 1112 engages a portion of the drive cylinder 1102 to limit the travel thereof to the right (as seen in FIG. 13).

While at least one exemplary embodiment has been presented in the foregoing detailed description, it should be appreciated that a vast number of variations exist. It should also be appreciated that the exemplary embodiment or exemplary embodiments are only examples, and are not intended to be models or otherwise limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. An enclosure comprising:
a body portion, the body portion having a first slotted opening;
a top portion including a lid component configured to rotate with respect to the body portion to provide access to an interior compartment of the enclosure; and
a locking assembly integral with the lid component, the locking assembly comprising:
an actuator component recessed within and rotatably coupled to a side surface of the lid component, the actuator component having a first threaded end portion and an actuator axis;
a drive cylinder having a second threaded end portion configured to receive the first threaded portion of the actuator component, wherein the drive cylinder is slideably coupled to the lid component such that rotation of the actuator component from a first position to a second position causes the drive cylinder to translate parallel to the actuator axis; and
a first latch structure rigidly coupled to the drive cylinder, the first latch structure configured to engage the first slotted opening in the first position, and disengage the first slotted opening in the second position.

2. The enclosure of claim 1, wherein:
the locking assembly includes at least one second latch structure rigidly coupled to the drive cylinder;
the body portion includes at least one second slotted opening; and
the at least one second latch is configured to engage and disengage the at least one second slotted opening in response to rotation of the actuator component.

3. The enclosure of claim 1, wherein rotation of the actuator component from the first position to the second position requires approximately one full turn.

4. The enclosure of claim 1, wherein the actuator component has a first end comprising a pentahead bolt feature.

5. The enclosure of claim 1, wherein the threaded end of the actuator component includes a plurality of helical lead-ins.

6. The enclosure of claim 1, wherein:
the lid component further includes first and second adjacent hasp openings configured to receive an external shackle member; and
the locking assembly includes a hasp access component configured to block the first hasp opening when the drive cylinder is in the first position, and to unblock the first hasp opening when the drive cylinder is in the second position.

7. The enclosure of claim 1, wherein the lid component is oriented at approximately a 45-degree angle with respect to a plane defined by a front portion of the body portion when the lid component is in a “closed” position.

8. The enclosure of claim 1, wherein the body portion includes a door providing access to the interior of the enclosure, further wherein the door is secured by a front edge of the lid portion when the lid portion is in a “closed” position.

9. A locking assembly for an enclosure, the locking assembly comprising:
an actuator component recessed within and rotatably coupled to a side surface of a lid component of the enclosure, the actuator component having a first threaded end portion and an actuator axis;
a drive cylinder having a second threaded end portion configured to receive the first threaded portion of the actuator component, the drive cylinder slideably coupled to the lid component of the enclosure such that rotation of the actuator component from a first position to a second position causes the drive cylinder to translate parallel to the actuator axis; and
a latch structure rigidly coupled to the drive cylinder, the latch structure configured to engage a slotted opening of the enclosure in the first position, and disengage the slotted opening in the second position.

10. The locking assembly of claim 9, wherein rotation of the actuator component from the first position to the second position requires approximately one full turn.

11. The locking assembly of claim 9, wherein the actuator component has a first end comprising a pentahead bolt feature.

12. The locking assembly of claim 9, wherein the threaded end of the actuator component includes a plurality of helical lead-ins.

13. The locking assembly of claim 9, wherein:
the locking assembly includes a hasp access component configured to block a hasp opening provided within the lid portion when the drive cylinder is in the first position, and to unblock the hasp opening when the drive cylinder is in the second position.

14. An enclosure comprising:
a body portion, the body portion having a front portion, two opposing side portions, and a back portions, the front portion having front edge surface comprising at least one slotted opening;
a lid component configured to rotate with respect to the body portion to provide access to an interior compartment of the enclosure, wherein the lid component is oriented at approximately a 45-degree angle with respect to a plane of the front portion of the body portion when the lid component is in a “closed” position;
a locking assembly integral with the lid component, the locking assembly comprising:
an actuator component recessed within and rotatably coupled to a side surface of the lid component, the actuator component having a first threaded end portion and an actuator axis;
a drive cylinder having a second threaded end portion configured to receive the first threaded portion of the actuator component, wherein the drive cylinder is slideably coupled to the lid component such that rotation of the actuator component from a first position to a second position causes the drive cylinder to translate parallel to the actuator axis; and
at least one latch structure rigidly coupled to the drive cylinder, the at least one latch structure configured to engage the at least one slotted opening in the first position, and disengage the at least one slotted opening in the second position.

15. The enclosure of claim 14, wherein rotation of the actuator component from the first position to the second position requires approximately one full turn.

16. The enclosure of claim 14, wherein the actuator component has a first end comprising a pentahead bolt feature.

17. The enclosure of claim 14, wherein the threaded end of the actuator component includes a plurality of helical lead-ins.

18. The enclosure of claim 14, wherein:
the lid component further includes first and second adjacent hasp openings configured to receive an external shackle member; and
the locking assembly includes a hasp access component configured to block the first hasp opening when the drive cylinder is in the first position, and to unblock the first hasp opening when the drive cylinder is in the second position.

19. The enclosure of claim 14, further including a stationary roof component adjacent the lid component and rigidly coupled to the two opposing side portions, wherein the lid component is hingedly coupled to the stationary roof component.

20. The enclosure of claim 14, wherein the body portion includes a door providing access to the interior of the enclosure, further wherein the door is secured by a front edge of the lid portion when the lid portion is in a “closed” position.
